(19) United States
(12) Patent Application Publication
(10) Pub. No.: US 2007/0078695 A1
(43) Pub. Date: Apr. 5, 2007

(54) Methods, systems, and computer program products for identifying assets for resource allocation

(76) Inventors: Virginia A. Zingelewicz, Scotia, NY (US); Helena Goldfarb, Niskayuna, NY (US); Corey N. Bufi, Troy, NY (US); Steven H. Azzaro, Schenectady, NY (US); Jeffrey S. Thetford, Cypress, TX (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/240,960

(22) Filed: Sep. 30, 2005

(51) Int. Cl. G05B 19/418

(52) U.S. Cl. 705/8

(57) ABSTRACT

Methods, systems, and computer program products for identifying assets for resource allocation are provided. The method includes gathering data that includes asset data and ambient area data. The asset data relates to each asset in an infrastructure and the ambient area data relates to a geographic region surrounding a corresponding asset. The method also includes analyzing the asset and ambient area data to determine the propensity for an event or condition, occurring within each ambient area, to have an unfavorable impact on the asset. The method further includes rating a severity of the unfavorable impact, and selecting at least one asset in the infrastructure for allocating a resource based upon the rating.

### BACKGROUND OF THE INVENTION

The present disclosure relates generally to asset integrity management, and more particularly, to methods, systems, and computer program products for identifying assets within an infrastructure for resource allocation.

In any given operational infrastructure, there may be actual or potential hazards that are unknown and undetectable by an entity that manages the infrastructure. For example, third party activities conducted at or near a location of an asset within the infrastructure may pose a threat to the asset, as well as the operational effectiveness of the infrastructure as a whole. In the pipeline industry, for example, activities conducted by third parties, such as construction workers at a building site or agricultural laborers at a farming site may cause damage or injury to nearby assets as a result of using heavy equipment. There are also third-party threats to assets that relate to malicious or intentional acts, the occurrence of which can have severe consequences to the infrastructure.

Providing resources to these assets for monitoring and pre-empting such threats are commonly relied upon. Such resources include sensor devices, camera or video equipment, and human resources, to name a few. However, in a geographically expansive infrastructure, it is difficult and often prohibitively expensive to provide and maintain these resources at a level that can provide adequate preventative cover.

What is needed, therefore, is a way to dynamically identify and evaluate the impacts of actual and potential threats or events on an asset infrastructure and to determine which assets to select for resource allocation.

### BRIEF SUMMARY OF THE INVENTION

Exemplary embodiments include a method for identifying assets within an infrastructure for resource allocation. The method includes gathering data that includes asset data and ambient area data. The asset data relates to each asset in an infrastructure and the ambient area data relates to a geographic region surrounding a corresponding asset. The method also includes analyzing asset and ambient area data to determine the propensity for an event or condition occurring within each ambient area to have an unfavorable impact on the asset. The method further includes rating a severity of the unfavorable impact, and selecting at least one asset in the infrastructure for allocating a resource based upon the rating.

The system for identifying assets within an infrastructure for resource allocation includes a host system in communication with a network and a storage device in communication with the host system. The storage device houses asset data relating to each asset in an infrastructure. The system also includes a network link to data sources providing ambient area data relating to a geographic region surrounding a corresponding asset and an asset management application executing on the host system. The asset management application performs a method. The method includes gathering data that includes the asset data and the ambient area data. The method also includes analyzing asset and ambient area data to determine the propensity for an event or condition occurring within each ambient area to have an unfavorable impact on the asset. The method further includes rating a severity of the unfavorable impact, and selecting at least one asset in the infrastructure for allocating a resource based upon the rating.

The computer program product for identifying assets within an infrastructure for resource allocation includes instructions for performing a method. The method includes gathering data that includes asset data and ambient area data. The asset data relates to each asset in an infrastructure and the ambient area data relates to a geographic region surrounding a corresponding asset. The method also includes analyzing asset and ambient area data to determine the propensity for an event or condition occurring within each ambient area to have an unfavorable impact on the asset. The method further includes rating a severity of the unfavorable impact, and selecting at least one asset in the infrastructure for allocating a resource based upon the rating.

### BRIEF DESCRIPTION OF THE DRAWINGS

Referring to the exemplary drawings wherein like elements are numbered alike in the accompanying Figures:

FIG. 1 is a block diagram of a system upon which the asset management activities may be implemented in exemplary embodiments;

FIG. 2 is a flow diagram illustrating a process for implementing the asset management activities in exemplary embodiments; and

FIG. 3 is a graphical depiction of a geographic area or region identified for resource allocation in exemplary embodiments.

### DETAILED DESCRIPTION OF THE INVENTION

In accordance with exemplary embodiments, a method, system, and computer program product for implementing asset management activities are provided. Asset management activities include identifying specific assets within an infrastructure for which resource allocation is desired. The asset management activities include gathering data relating to an asset, as well as an ambient area of the asset, and evaluating the effects or impact that an event or condition is likely to have on the asset, the ambient area, and/or other elements. An asset refers to items (e.g., structures, vehicles, equipment, real property, etc.) that collectively make up an infrastructure. An ambient area of the asset refers to a specified region that surrounds the asset. An infrastructure, as used herein, refers to basic facilities, services, and installations utilized in order to enable an organization or system to function. Thus, if the infrastructure relates to transportation systems, for example, the assets may include roads, highways, bridges, etc. For illustrative purposes, the assets described herein refer to pipelines, or portions thereof.

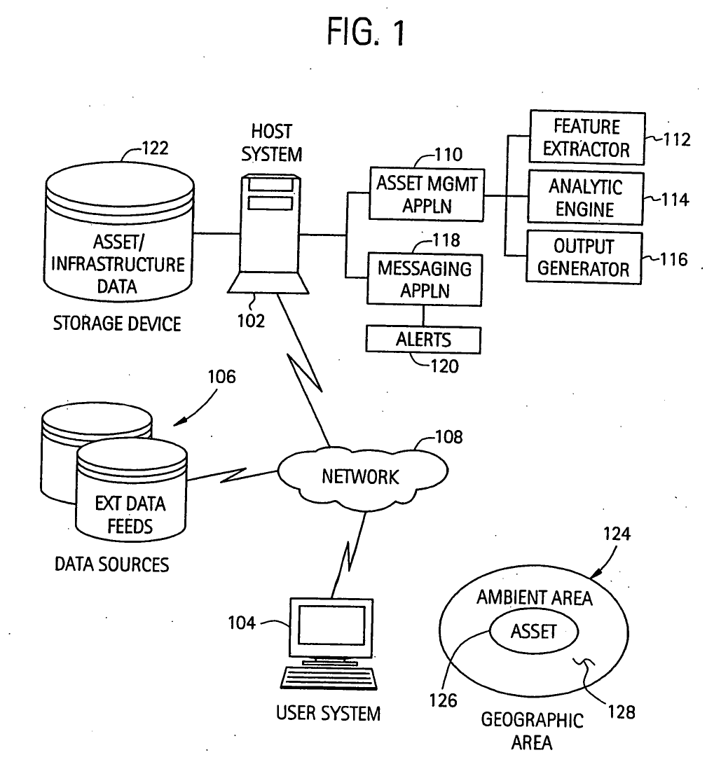

Turning now to FIG. 1, a block diagram of a system upon which the asset management activities may be implemented in accordance with exemplary embodiments will now be described. The system of FIG. 1 includes a host system 102 in communication with a user system 104 and data sources 106 over a network 108.

Host system 102 may be implemented using one or more servers or suitable high-speed processors operating in response to a computer program stored in a storage medium accessible by the server or servers. The host system 102 may operate as a network server (e.g., a web server) to communicate with network entities such as user system 104 and data sources 106. The host system 102 may handle sending and receiving information to and from network entities, e.g., user system 104 and may perform associated tasks.

Host system 102 may also operate as an application server. In accordance with exemplary embodiments, the host system 102 executes one or more computer programs to perform asset management activities. These one or more computer programs are referred to collectively herein as an asset management application 110.

As previously described, it is understood that separate servers may be utilized to implement the network server functions and the application server functions of host system 102. Alternatively, the network server and the application server may be implemented by a single server executing computer programs to perform the requisite functions described with respect to host system 102.

The asset management application 110 may include a user interface (UL) for enabling individuals to perform activities, such as configuring which asset features will be extracted, assigning weighting criteria to the features, and selecting which data sources will be monitored for information. The asset management application 110 includes a feature extractor 112, an analytic engine 114, and an output generator 116.

The feature extractor 112 filters data received from sources, such as data storage device 122 and external data sources 106. The feature extractor 112 enables a user of the application 110 to select which features of an asset are to be considered in implementing the asset management activities described herein. The analytic engine 114 receives the filtered data and evaluates the impact of events and/or conditions on the asset, the ambient area of the asset, and/or other elements. The user of the application 110 may also provide the criteria for facilitating these determinations. Once the evaluation is performed, the output generator 116 creates a profile of the results and an alert is generated for assets that meet the criteria for resource allocation. The profile may be in the form of text, video, or images (e.g., satellite images). The images may include the profile deposited thereon.

The host system 102 may also employ a messaging application 118 for transmitting alerts 120 generated by the asset management application 110. The alerts 120 may include specific information concerning an asset that is selected (or proposed) for receiving specified resources. The alerts 120 are sent to entities (e.g., user system 104) that are responsible for monitoring the assets. For example, as shown in FIG. 1, a single asset 126 is maintained or managed by an entity of user system 104. An ambient area 128 surrounds the asset 126. Collectively, the asset 126 and ambient area 128 are referred to as a geographic area 124 or region.

Host system 102 is in communication with a storage device 122, which may be implemented using a variety of devices for storing electronic information. It is understood that the storage device 122 may be implemented using memory contained in the host system 102, or it may be a separate physical device. The storage device 122 is logically addressable as a consolidated data source across a distributed environment that includes network 108. Information stored in the storage device 122 may be retrieved and manipulated via the host system 102. In an exemplary embodiment, the host system 102 operates as a database server and coordinates access to application data including data stored on storage device 122.

Storage device 122 stores a variety of information and content relating to assets associated with an infrastructure for which the asset management activities are performed. Using the pipeline industry example, examples of the types of information (also referred to as asset data) stored in storage device 122 and managed by the asset management application 110 may include: age of the pipeline, pipeline manufacturer, pipeline specifications, coatings, exposure (e.g., above ground or buried, and depth), geographic location of pipeline, performance history of pipeline, maintenance history of pipeline, utilization of pipeline (e.g., nature and frequency of use), etc. One or more databases may be utilized for organizing this information. For example, the organization of host system 102 may maintain database records for each of its assets which provide, e.g., maintenance, repair, and utilization information, etc.

The asset management application 110 may access information available from external data sources 106 and utilize this information in analyzing ambient area activities and/or conditions that may affect a corresponding asset and/or ambient area in the infrastructure. External data sources 106 refer to sources of information that are external to the host system 102, and may be provided by one or more third parties. Examples of external data sources may include: newspapers, government websites, land surveys, architectural data sources, online public records, weather databases, military or government intelligence data sources, etc.). The external data sources 106 may be implemented using one or more servers operating in response to a computer program stored therein or in a storage medium accessible by the server or servers (e.g., in a manner similar to that described above with respect to host system 102).

The external data sources 106 may be used as continuous data feeds to the host system 102. Types of ambient area data retrieved from the data feeds may include: construction plans, public works plans and schedules, seasonal activities (e.g., farming), weather forecasts, issued or potential threats to homeland security, etc.

Network 108 may be any type of known network including, but not limited to, a local area network (LAN), a wide area network (WAN), a global network (e.g. the Internet), a private network (e.g. an Intranet), and a virtual private network (VPN). The network 108 may be implemented using a wireless network or any kind of physical network implementation known in the art. Network entities (e.g., external user system 104), may be coupled to the host system 102 through multiple networks (e.g., intranet and Internet) so that not all network entities are coupled to the host system 102 through the same network. One or more of the network entities and the host system 102 may be connected to the network 108 in a wireless fashion.

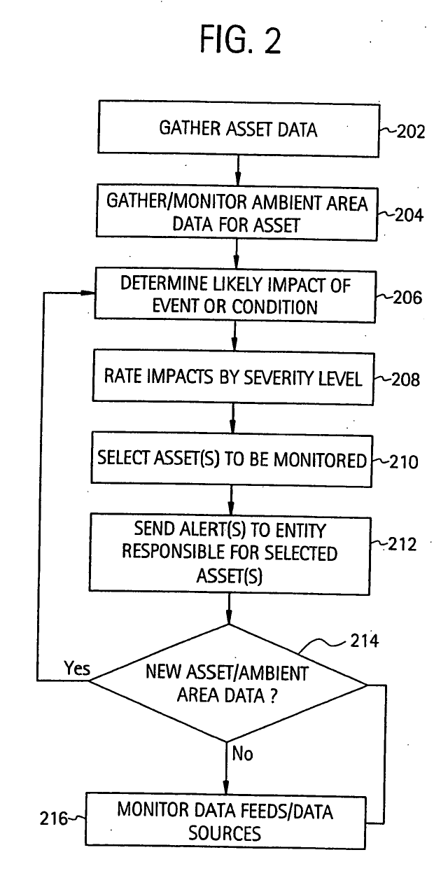

Turning now to FIG. 2, a flow diagram illustrating a process for implementing the asset management activities will now be described in accordance with exemplary embodiments. At step 202, asset data is gathered by the asset management application 110. Asset data may be static or dynamic. For example, the specifications of an asset would be static information that is constant over time. By contrast, dynamic asset data may be the utilization of the asset, which may change over time. Ambient area data is gathered via the data sources 106 at step 204. Ambient data may also be static or dynamic. Static ambient information may be, e.g., the terrain of the ambient area (e.g., mountainous, altitude, etc.), whereas dynamic ambient information may include seasonal climate, land use, etc. This data may be continuously monitored for changes. Feature extractor 112 filters the data according to criteria selected by a user of the asset management application 110 or may alternatively be pre-defined as a default.

At step 206, the filtered asset data and ambient area data are fed to the analytic engine 114. Using this data, the analytic engine 114 analyzes the asset and ambient area data to determine the likely impact an occurrence of an event or condition within the ambient area will have on the asset, the ambient area, or other elements. An event may be an actual event or hypothetical event. For example, an actual event may be a construction project that is underway or planned, a farming operation that involves plowing or other heavy equipment usage, routine maintenance on a roadway or communications lines by a utilities company or public works department, etc. A hypothetical event may be a real or anticipated threat or potential threat. For example, a hypothetical event may include a natural disaster (e.g., earthquake, flood, storm, etc.) or may be a malicious act, act of terrorism, etc. for which planning and preparedness are desired.

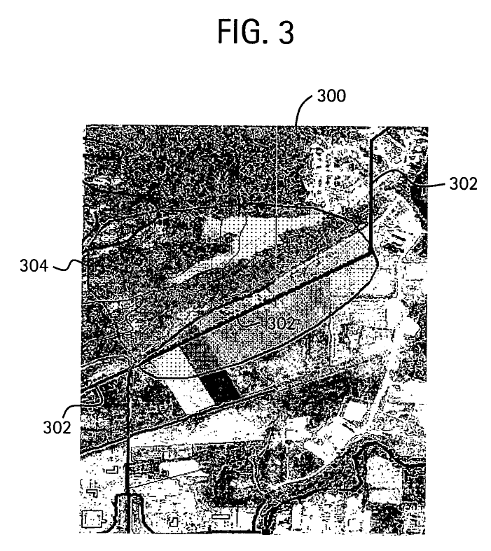

At step 208, the impact of the occurrence is rated according to a severity level. The impacts of these events vary depending upon the type and severity of threat, as well as the type, condition, location, etc. of the asset with respect to the event. Impacts considered may include financial or economic losses, environmental hazards or damage, injuries or harm to health and safety (e.g., if the asset is located in highly populated area), etc. The analytic engine 114 provides the ability to evaluate the events, factoring in the particular asset data, ambient data, and business policies in order to determine which assets should be provided with protective or preventative resources (e.g., monitoring devices, sensors, human resources, etc.). For example, while a hypothetical event such as malicious damage to a particular asset may pose a severe threat, such threat may be mitigated when factoring in ambient data that indicates the asset is located in a remote and relatively inaccessible geographic region (e.g., extreme climate conditions, mountainous terrain, etc.). At step 210, one or more assets are selected for resource allocation based upon the impact severity ranking. An output image of the geographic area may be generated by the output generator 116, a sample of which is shown in FIG. 3.

The image 300 of FIG. 3 illustrates a satellite image of a geographic region including an asset 302 (e.g., pipeline). The profile of the asset 302 indicates that a portion 302₁, encircled by an ambient area 304 is selected or proposed for resource allocation by the asset management application 110.

At step 210, an alert 120 is sent to an entity that is responsible for monitoring the selected asset(s), e.g., user system 104. The alert 120 may provide details of the asset for which resource allocation is advised or required. The alert 120 may also provide information regarding the event (e.g., construction project ongoing, intelligence information suggesting potential threat, etc.). The alert 120 may also provide information regarding the likely or anticipated impact of the event, as well as other information.

At step 212, it is determined whether any new or changed asset and/or ambient area data is detected via the data feeds. If so, the process returns to step 206 for an impact evaluation and determination using the new data. Otherwise, the data feeds of data sources 106 continue to be monitored at step 216 and the process returns to step 214. New data feeds may be added/removed over time as conditions warrant.

As described above, asset management activities provide the ability to identify specific assets within an infrastructure for which resource allocation is desired. The asset management activities include gathering data relating to an asset, as well as an ambient area of the asset, and evaluating the effects or impact that an event or condition is likely to have on the asset, the ambient area, and/or other elements. Upon evaluating the impact, one or more assets are selected for resource allocation and an alert to a responsible entity is generated and transmitted. As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to identify assets of an infrastructure for resource allocation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for identifying assets for resource allocation, comprising:
gathering data that includes asset data and ambient area data, the asset data relating to each asset in an infrastructure and the ambient area data relating to a geographic region surrounding a corresponding asset;
analyzing the asset data and the ambient area data to determine a propensity for an event or condition, occurring within each ambient area, to have an unfavorable impact on the asset;
rating a severity of the unfavorable impact; and
selecting at least one asset in the infrastructure for allocating a resource based upon the rating.

2. The method of claim 1, further comprising dynamically updating at least one of the asset data and the ambient area data; wherein the determining a propensity for an event or condition, the rating a severity, and the selecting are based upon updated data.

3. The method of claim 1, wherein the asset data includes at least one of:
age of the asset;
manufacturer of the asset;
specifications of the asset;
exposure of the asset;
geographic location of the asset;
performance history of the asset;
maintenance history of the asset; and
utilization of the asset.

4. The method of claim 1, wherein the event includes at least one of:
an actual event that poses a risk, including at least one of:
a construction project that is underway or planned;
a farming operation that involves heavy equipment usage;
maintenance performed on a roadways;
maintenance performed in an area surrounding the asset;
maintenance performed on communications systems; and
a hypothetical event that poses a risk, including at least one of:
a natural disaster;
a malicious act of vandalism; and
an act of terrorism.

5. The method of claim 1, wherein the ambient data includes at least one of:
terrain of the ambient area;
climate of the ambient area;
land use of the ambient area;
population of the ambient area;
maintenance plans and schedules for the ambient area;
weather forecasts for the ambient area; and
military intelligence information that relates to the ambient area.

6. The method of claim 1, wherein the unfavorable impact includes at least one of:
financial loss;
economic loss;
environmental hazard;
environmental damage; and
injuries to health and safety.

7. The method of claim 1, further comprising generating an alert and transmitting the alert to an entity managing the at least one asset; wherein the resource includes at least one of:
a monitor;
a sensor; and
a human resource.

8. A system for identifying assets for resource allocation, comprising:
a host system in communication with a network;
a storage device in communication with the host system, the storage device housing asset data relating to each asset in an infrastructure;
a network link to data sources providing ambient area data relating to a geographic region surrounding a corresponding asset; and
an asset management application executing on the host system, performing:
gathering data that includes the asset data and the ambient area data;
analyzing the asset data and the ambient area data to determine a propensity for an event or condition, occurring within each ambient area, to have an unfavorable impact on the asset;
rating a severity of the unfavorable impact; and
selecting at least one asset in the infrastructure for allocating a resource based upon the rating.

9. The system of claim 8, wherein the asset management application further performs:
dynamically updating at least one of the asset data and the ambient area data; wherein the determining a propensity for an event or condition, the rating a severity, and the selecting are based upon updated data.

10. The system of claim 8, wherein the asset data includes at least one of:
age of the asset;
manufacturer of the asset;
specifications of the asset;
exposure of the asset;
geographic location of the asset;
performance history of the asset;
maintenance history of the asset; and
utilization of the asset.

11. The system of claim 8, wherein the event includes at least one of:
an actual event that poses a risk, including at least one of:
a construction project that is underway or planned;
a farming operation that involves heavy equipment usage;
maintenance performed on a roadways;
maintenance performed in an area surrounding the asset;
maintenance performed on communications systems; and
a hypothetical event that poses a risk, including at least one of:
a natural disaster;
a malicious act of vandalism; and
an act of terrorism.

12. The system of claim 8, wherein the ambient data includes at least one of:
terrain of the ambient area;
climate of the ambient area;
land use of the ambient area;
population of the ambient area;
maintenance plans and schedules for the ambient area;
weather forecasts for the ambient area; and
military intelligence information that relates to the ambient area.

13. The system of claim 8, wherein the unfavorable impact includes at least one of:
financial loss;
economic loss;
environmental hazard;
environmental damage; and
injuries to health and safety.

14. The system of claim 8, wherein the asset management application further performs:
generating an alert and transmitting the alert to an entity managing the at least one asset; wherein the resource includes at least one of:
a monitor;
a sensor; and
a human resource.

15. A computer program product for identifying assets for resource allocation, the computer program product including instructions for implementing a method, the method comprising:
gathering data that includes asset data and ambient area data, the asset data relating to each asset in an infrastructure and the ambient area data relating to a geographic region surrounding a corresponding asset;
analyzing the asset data and the ambient area data to determine a propensity for an event or condition, occurring within each ambient area, to have an unfavorable impact on the asset;
rating a severity of the unfavorable impact; and
selecting at least one asset in the infrastructure for allocating a resource based upon the rating.

16. The computer program product of claim 15, further comprising instructions for implementing:
dynamically updating at least one of the asset data and the ambient area data; wherein the determining a propensity for an event or condition, the rating a severity, and the selecting are based upon updated data.

17. The computer program product of claim 15, wherein the asset data includes at least one of:
age of the asset;
manufacturer of the asset;
specifications of the asset;
exposure of the asset;
geographic location of the asset;
performance history of the asset;
maintenance history of the asset; and
utilization of the asset.

18. The computer program product of claim 15, wherein the event includes at least one of:
an actual event that poses a risk, including at least one of:
a construction project that is underway or planned;
a farming operation that involves heavy equipment usage;
maintenance performed on a roadways;
maintenance performed in an area surrounding the asset;
maintenance performed on communications systems; and
a hypothetical event that poses a risk, including at least one of:
a natural disaster;
a malicious act of vandalism; and
an act of terrorism.

19. The computer program product of claim 15, wherein the ambient data includes at least one of:
terrain of the ambient area;
climate of the ambient area;
land use of the ambient area;
population of the ambient area;
maintenance plans and schedules for the ambient area;
weather forecasts for the ambient area; and
military intelligence information that relates to the ambient area.

20. The computer program product of claim 15, further comprising instructions for implementing:
generating an alert and transmitting the alert to an entity managing the at least one asset; wherein the resource includes at least one of:
a monitor;
a sensor; and
a human resource.
